(19) United States
(12) Patent Application Publication
(10) Pub. No.: US 2010/0003444 A1
(43) Pub. Date: Jan. 7, 2010

(54) MANUFACTURING METHOD FOR MULTILAYER INFORMATION RECORDING MEDIUM, MANUFACTURING APPARATUS FOR MULTILAYER INFORMATION RECORDING MEDIUM, AND MULTILAYER INFORMATION RECORDING MEDIUM

(75) Inventors: Masahiko Tsukuda, Osaka (JP); Morio Tomiyama, Nara (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/373,749

(22) PCT Filed: Oct. 16, 2007
(86) PCT No.: PCT/JP2007/070194

§ 371 Date: Jan. 14, 2009

(30) Foreign Application Priority Data
Oct. 18, 2006 (JP) 2006-284399

(51) Int. Cl. B32B 3/02; B05D 5/00; B05C 5/00

(52) U.S. Cl. 428/64.4; 427/256; 118/313

(57) ABSTRACT

An apparatus for manufacturing a multi-layered information recording medium of the present invention is an apparatus for manufacturing the multi-layered information recording medium for discharging a stiffening resin to a substrate while relatively moving at least one of the substrate and ink jet heads wherein the apparatus has a plurality of ink jet heads disposed on every different kind of the discharged stiffening resin, and constituted so as to stack-coat the stiffening resin to the substrate. With the constitution, a resin intermediate layer of a thick film, for example, greater than 10 μm having uniform thickness distribution and excellent in surface smoothness can be formed.

### CROSS-REFERENCE TO RELATED APPLICATIONS

This application is a U.S. national phase application of PCT International Patent Application No. PCT/JP2007/070194 filed on Oct. 16, 2007, claiming the benefit of priority of Japanese Patent Application No. 2006-284399 filed on Oct. 18, 2006, all of which are incorporated by reference herein in their entirety.

### FIELD OF THE INVENTION

The present invention concerns an information recording medium comprising stacked radiation-stiffening resin layers in lamination with an aim of reproduction or recording and reproduction and a method of manufacturing thereof and it particularly relates to a multi-layered information recording medium having two or more information layers, and a method of manufacturing thereof, and an apparatus for manufacturing thereof.

### RELATED ART OF THE INVENTION

In recent years, studies have been proceeded on optical information recording systems and they have now been used generally in industrial or domestic applications. Particularly, optical information recording media capable of recording information at high density such as CD and DVD have been popularized. The optical information recording medium is constructed by forming an information layer by stacking a metal thin film or a thin film material capable of thermal recording above a transparent substrate formed with an information surface of a concave/convex shape such as pits for representing information signals or guide grooves for tracking a recording or reproduction light and further stacking a protection layer such as a resin layer or a transparent substrate for protecting the information layer from moisture in atmospheric air. Information is reproduced, for example, by irradiating a laser light to the information layer and detecting the change of an optical amount of a reflection light.

For example, in a case of a CD, it is manufactured by forming an information layer by stacking a metal thin film or a thin film material above a resin substrate of about 1.1 mm thickness having an information surface of a concave/convex shape on one side, and then coating a radiation-stiffening resin typically represented, for example, by a UV-ray stiffening resin thereby forming a protection layer. Information signals are reproduced by entering a laser light not on the side of the protection layer but on the side of the substrate.

Further, in a case of a DVD, it is manufactured by forming an information layer by stacking a metal thin film or a thin film material on an information surface of a concave/convex shape above a resin substrate of about 0.6 mm thickness and then bonding a separately prepared resin substrate of about 0.6 mm thickness, for example, by a UV-ray stiffening resin.

Now, a demand for increasing the capacity in such optical information recording media has been increased and the information layer is intended to be formed as a multilayer in the DVD or the like, and an optical information recording medium of a 2-layered structure in which information layers are formed by sandwiching therebetween an intermediate layer of several tens μm thickness has been proposed.

Further, along with popularization of digital high vision broadcasting in recent years, an optical information recording medium in next generation of higher density and larger capacity than those of the DVD has been demanded, and a large capacity medium such as a Blu-ray disk has been proposed in which an information layer is formed by stacking a metal thin film or the like on an information surface of a concave/convex shape on a substrate of 1.1 mm thickness and a protection layer of about 0.1 mm thickness is formed on the information layer.

In the Blu-ray disk, the track pitch of the information layer is narrower and the size of the pit is smaller compared with a DVD. Accordingly, it is necessary to restrict the spot of a laser on the information layer for conducting recording or reproduction of information.

In the Blu-ray disk, the spot of the laser light is restricted on the information layer by using an optical head that uses a blue-purple laser at a short wavelength of the laser light of 405 nm, and using an objective lens having a numerical aperture (NA) of 0.85 for restricting the laser light.

However, as the spot is decreased in the size, it tends to undergo the effect by the tilt of a disk to result in a subject that distortion is generated in the restricted beam by the generation of aberration in the beam spot when the disk tilts even slightly and this makes recording or reproduction no more possible. Accordingly, in the Blu-ray disk, such a drawback is compensated by decreasing the thickness of the protection layer on the laser incident side of the disk to about 0.1 mm.

By the way, also in the optical information recording medium in next generation of a large capacity such as the Blu-ray disk, increase in the capacity of the memory capacity by forming the information layer as a multilayer has been proposed as in the DVD.

FIG. 8 shows a cross sectional view of a 2-layered Blue-ray disk having two information layers.

A first information layer 203 is formed by stacking a metal thin film or a thin film material capable of thermal recording on a molded resin substrate 201 in which a first information surface 202 of a concave/convex shape is formed on one side. A resin intermediate layer 204 substantially transparent to a recording or reproduction light is formed on the first information layer 203, and a second information surface 205 of a concave/convex shape is formed on the resin intermediate layer 204.

A second information layer 206 is formed by stacking a metal thin film translucent to the recording or reproduction light or a thin film material capable of thermal recording on the second information surface 205. Then, a protection layer 207 is formed by coating a resin substantially transparent to the recording or reproduction light so as to cover the second information layer 206.

Substantially transparent means herein to have a transmittance of about 90% or higher to the recording or reproduction light and translucent means to have a transmittance of 10% or higher and 90% or lower to the recording or reproduction light. The 2-layered Blu-ray disk can record or reproduce signals by entering a laser light on the side of the protection layer 207, and focusing the same to the information layer for conducting recording or reproduction in the first or the second information layer.

It is defined such that the thickness of the molded resin substrate 201 is about 1.1 mm, the thickness of the resin intermediate layer 204 is about 25 μm, and the thickness of the protection layer 207 is about 75 μm.

The method of manufacturing such a multi-layered Blu-ray disk is generally conducted as described below. As an example, a method of manufacturing a 2-layered Blu-ray disk is to be described.

FIG. 9 shows steps of manufacturing a stamper as a metal die for manufacturing a molded resin substrate on an information recording medium. At first, a light sensitive material such as a photoresist is coated on an original plate 301 comprising a glass plate or a silicon wafer to prepare a light sensitive film 302 and a pattern such as pits or guide grooves is exposed by using an exposure beam 303 such as a laser light or an electron beam (refer to FIG. 9(a)).

This forms latent images comprising an exposure portion 304 (refer to FIG. 9(b)).

Then, when the exposure portion 304 is removed, for example, by an alkali developer, a recording original plate 306 formed with a concave/convex pattern 305 by the light sensitive material is obtained on the original plate 301 (refer to FIG. 9(c)).

A conductive thin film 307 is formed on the surface of the recording original plate 306 by using, for example, a sputtering method or a vapor deposition method (refer to FIG. 9(d)).

A metal plate 308 is formed by metal plating or the like using the conductive thin film 307 as an electrode (refer to FIG. 9(e)).

Then, a metal stamper 309 as a metal die for molding a resin substrate is prepared by peeling the conductive film 307 and the metal plate 308 at the boundary between the light sensitive film 302 and the conductive thin film 307, removing the light sensitive material remaining on the surface of the conductive film 307 by a removing material or the like and conducting punching molding to inner and outer diameters conforming to a molding machine (refer to FIG. 9(f)).

Then, a resin substrate is molded by a resin molding method by an injection molding method or the like using the metal stamper 309. As the substrate material, materials such as polycarbonate of excellent moldability are often used. Then, resin layers are stacked by adopting, for example, a resin layer forming step using, for example, a spin coat method as shown in JP-A No. 2002-092969.

The disclosures in the JP-A No. 2002-092969 are incorporated herein by reference in its entirety.

FIG. 10(a) to FIG. 10(i) are views showing manufacturing steps of a 2-layered disk including steps of preparing a resin intermediate layer and a protection layer using a spin coat method.

A molded resin substrate 401 of about 1.1 mm thickness having a first information surface formed with pits or guide grooves having a concave/convex shape on one side is formed by a resin molding method such as an injection molding method by using a metal stamper 309. Then, a first information layer 402 is formed by forming a metal thin film or a thin film material capable of thermal recording on the first information surface by a sputtering method or a vapor deposition method. The molded resin substrate 401 formed with the first information layer 402 is fixed on a rotational stage 403 by a method such as vacuum suction (refer to FIG. 10(a)).

A radiation-stiffening resin C(404) is coated concentrically along a desired radius by a dispenser on the first information layer 402 on the molded resin substrate 401 fixed on the rotational stage 403 (refer to FIG. 10(b)), and the radiation ray-stiffening resin C(404) is extended by spin-rotating the rotational stage 403 to form a resin layer 406 (refer to FIG. 10(c)).

In this step, the thickness of the resin layer 406 can be controlled to a desired thickness by optionally setting the viscosity of the radiation-stiffening resin C (404), the number of times of rotation of the spin rotation, the rotation time, and the ambient atmosphere for spin rotation (for example, temperature, humidity), etc. After stopping the spin rotation, the resin layer 406 is cured by irradiation of radiation rays from a radiation ray irradiator 405.

Then, a transfer stamper 407 for forming a second information surface is formed by an injection molding method by using the metal stamper 309 as shown in FIG. 9(f). The transfer stamper (407) is fixed on a rotational stage 408 by vacuum suction or the like.

A radiation-stiffening resin D (409) is coated concentrically along a desired radius by a dispenser on the transfer stamper 407 fixed to a rotational stage 408 (refer to FIG. 10(d)), and the radiation-stiffening resin D (409) is extended by spin-rotating the rotational stage 408 to form a resin layer 411 (refer to FIG. 10(e)).

The thickness of the resin layer 411 can be controlled to a desired thickness as has been described previously. After stopping the spin rotation, the resin layer 411 is cured by irradiation of radiation rays from a radiation ray irradiator 410.

Then, the molded resin substrate 401 formed with the resin layer 406 and the transfer stamper 407 formed with the resin layer 411 as described above are stacked to each other by way of a radiation-stiffening resin E (412) such that the respective resin layer 406 and the resin layer 411 are opposed to each other above a rotational stage 413 (refer to FIG. 10(f)). By spin rotating the rotational stage 413 in a state where the resin layers 406 and 411 are integrated, the radiation-ray stiffening resin E (412) is extended to form a resin layer 414 controlled to a desired thickness. Then, radiation rays are irradiated by a radiation ray irradiator 415 to conduct curing (refer to FIG. 10(g)).

After integrating the molded resin substrate 401 and the transfer stamper 407 by the radiation ray-stiffening resin E (412), the transfer stamper 407 is peeled at the boundary between the transfer stamper 407 and the resin layer 411 formed of the radiation-stiffening resin D (409) to form a second information layer above the molded resin substrate 401 (refer to FIG. 10(h)).

After forming a second information layer 416 by forming a metal thin film or a thin film material capable of thermal recording on the second information surface, for example, by a sputtering method or a vapor deposition method, a radiation-stiffening resin F is coated by the same spin coat method and radiation-cured to form a protection layer 417 (refer to FIG. 10(i)). Depending on the case, a hard coat layer or the like is formed sometimes for preventing defects on the surface of the protection layer caused by injuries or deposition of finger prints.

The 2-layered Blu-ray disk is thus completed.

For the radiation-stiffening resin C (404) used herein, those materials of good adhesion with the first information 402 and the resin layer 414 formed of the radiation-stiffening resin E (412) are used. Further, for the resin layer 411 formed of the radiation-stiffening resin D (409), those having good releasability from the transfer stamper 407 and good adhesion with the resin layer 414 formed of the radiation-stiffening resin E (412) are used.

Further, for the radiation-stiffening resins C, D, E, and F, those substantially transparent to the wavelength of the recording or reproduction light are used. Further, while description has been made to the preparation steps of the resin intermediate layer using four kinds of radiation-stiffening resins, there is a simpler method of decreasing the number of kinds of the radiation-stiffening resins, for example, by controlling the releasability with the radiation-stiffening resin by selecting the material for the transfer stamper, etc.

Further, as the method of forming the resin layer, not only the method by the spin coat method described here but also a method by the screen printing method or the like is proposed. In this method, only the step for forming the radiation-stiffening resin layer is changed from the spin coat method to the screen printing method and other steps are conducted substantially by way of the same process.

### BRIEF DESCRIPTION OF THE INVENTION

However, in a case of forming the resin intermediate layer by the spin coat method, a subject is present that formation of a radiation-stiffening resin layer of uniform thickness is difficult mainly attributable to that the resin is supplied only to the specified region or that the centrifugal force utilized for extension is different depending on the radial position. Further, since the resin reaches as far as the outer circumferential end face of the molded resin substrate, this result is a subject that the resin layer is raised at the outermost circumference undergoing the effect of the surface tension at the end face.

Further, since the spin coat method tends to undergo the effect of unevenness on the coated surface, spin coat is conducted on a previously formed resin intermediate layer in a case of manufacturing a multi-layered information recording medium having a 3-layered or 4-layered information layers or in a case of forming the protection layer. Therefore, the uniformity of the thickness may possibly be worsened further.

Further, in a case of using the spin-coat method, it takes about ten seconds upon coating the radiation-stiffening resin for once, which also causes lowering of the productivity in the manufacture of the multi-layered information recording medium.

Further, in a case of the spin coat method, since the resin layer is formed while partially throwing off a resin dropping on the substrate, it is necessary to drop a more the resin than that necessary for the resin intermediate layer actually formed on the substrate. Accordingly, the thrown off resin is discarded as it is, or has to be re-used by way of an additional process such as recycling, so that this also lowers the productivity.

Further, in the step of forming the resin intermediate layer by the screen printing method, uniform thickness can be attained easily compared with the spin coat method. However, since the screen is in contact with the surface of the information layer or the transfer stamper upon coating, it results in a problem of directly or indirectly generating injuries or dusts to the information layer.

Further, in the screen printing method, since the resin is supplied only through the pore portions apertured in the screen, it results in a problem that bubbles tend to intrude in portions not supplied with the resin.

Further, also in the screen printing method, for coating the resin to a desired region, it is necessary to apply a mask so as to shield portions other than the desired coating region and it is also necessary to align the mechanical position with the coated surface at a good accuracy.

Further, also in the screen printing method, like in the spin coat method, the resin has to be supplied in an amount more than that necessary for the resin intermediate layer to be formed actually on the substrate. Accordingly, the unused resin is discarded or has to be re-utilized by way of an additional process such as recycling and this also lowers the productivity.

As one of means for solving the subjects regarding the spin coat method or the screen printing method, a coating method by an ink jet method capable of contactless coating not requiring any special mask or the like to the desired coating region may also be considered.

The ink jet method is a technique of discharging fine droplets with a volume of about 1 pL to 1 nL from the nozzle and the nozzle used for such discharge is referred to as an ink jet nozzle.

FIG. 11 shows a typical constitutional example of an inkjet nozzle as a cross sectional view. A supply channel for a discharged liquid to be discharged, a liquid tank or the like is not illustrated in the drawing. FIG. 11(a) shows a type of extruding and discharging a discharge liquid 501 by a vibration device 502 such as a piezoelectric device and this is referred to as a piezo ink jet nozzle. FIG. 11(b) shows a type of instantaneously boiling a discharge liquid using a heater 503 thereby conducting discharge utilizing volume expansion of a discharge liquid 504 near the heater as a power source and this is referred to as a thermal system.

In addition, while there are various methods of discharging the resin, only the discharge liquid of a low viscosity can be discharged due to the structure of discharging fine droplets from a small diameter ink jet nozzle in common with them. This dose not mean that the viscosity of the discharge liquid in a liquid tank at a normal temperature but just means the resin viscosity at the periphery of the discharge port of the ink jet nozzle.

Accordingly, a method of heating the vicinity of the discharge port of the ink jet nozzle by a heater or the like thereby discharging the discharge liquid while lowering the viscosity thereof is used sometimes.

In ink jet nozzles which are used generally or marketed at present, the viscosity of the dischargeable discharge liquid near the discharge port is from about several mPa·s to several tens mPa·s. Therefore, in the manufacture of the resin intermediate layer by the ink jet method, a resin at a low viscosity is discharged which tends to cause flow of the resin after coating, and since only the fine droplets with a volume of about 1 pL to 1 nL can be discharged as described previously, it is extremely difficult to coat a resin layer at a thickness, for example, of more than 10 μm.

In order to form a thick resin layer of more than 10 μm in such an ink jet method, it is necessary to coat a resin of a viscosity as high as possible within a range capable of discharging from the ink jet nozzle. However, in the resin layer formed with an assembly fine liquid droplets by the ink jet method, a fine thickness distribution is caused depending on the droplet hit pattern when the viscosity increases excessively, and this also worsens the surface smoothness.

Such worsening for the surface smoothness of the resin intermediate layer results in worsening of the surface smoothness of the information layer formed on the resin intermediate layer as in the Blu-ray disk and this makes focus control unstable upon information recording or reproduction. While it may be possible to improve the smoothness on the surface of the resin layer by providing a certain leveling time, the productivity is lowered as the leveling time is longer.

One aspect of the present invention aims to solve the subject in the existent ink jet method, and provide a method of manufacturing a multi-layered information recording medium of preparing a resin intermediate layer of a desired uniform thickness even for a resin layer of a thickness of, for example, more than 10 μm, and attaining good surface smoothness, and having good signal characteristics, a manufacturing apparatus for multi-layered information recording medium, and a multi-layered information recording medium.

The 1^{st} aspect of the present invention is a method of manufacturing a multi-layered information recording medium at least having a substrate, a plurality of information layers disposed above the substrate, a resin intermediate layer disposed between each of the information layers, and a protection layer disposed above the information layers, in which

formation of the resin intermediate layer includes an ink jet coating step of stack-coating at least two kinds of stiffening resins of different viscosities above the substrate while relatively moving at least one of the substrate and the ink jet head, and,

a step of transferring and forming an information surface to the stiffening resin.

Thus, a multi-layered information recording medium having a resin intermediate layer of a uniform thickness distribution and also excellent in the surface smoothness can be manufactured.

By the use of the method, a thick film resin layer, for example, of more than 10 μm can be formed.

The 2^{nd} aspect of the present invention may be a method of manufacturing a multi-layered information recording medium according to the 1^{st} aspect of the present invention, wherein a discharge width of the stiffening resin in the ink jet head is equal to or greater than a width of the substrate in a relation perpendicular to a running direction of the ink jet head.

With the constitution described above, dropping of the resin droplet is possible by relative movement for once over all coating regions on the coating object upon relatively moving one of the coating object and the ink jet head.

The 3^{rd} aspect of the present invention may be a method of manufacturing a multi-layered information recording medium according to the 1^{st} aspect of the present invention or the 2^{nd} aspect of the present invention, wherein the stiffening resin is stiffened on every coating to the substrate and a next stiffening resin is coated after stiffening.

With the constitution described above, excessive flow of the coated resin can be suppressed, and a uniform thickness distribution can be attained.

The 4^{th} aspect of the present invention may be a method of manufacturing a multi-layered information recording medium according any one of the 1^{st} aspect of the present invention through the 3^{rd} aspect of the present invention, wherein the stiffening resins are coated in order of higher viscosity.

By the use of the method, the surface layer of the resin layer is formed of a radiation-stiffening resin of low viscosity that can more easily levels the surface layer of the resin layer, and good surface smoothness can be obtained.

The 5^{th} aspect of the present invention may be a method of manufacturing a multi-layered information recording medium according to any one of the 1^{st} aspect of the present invention through the 3^{rd} aspect of the present invention, wherein the stiffening resins are coated in order of lower viscosity.

By the use of the method, a good surface smoothness can be obtained by making the surface smoothness of the coating surface preferable with the radiation-stiffening resin of low viscosity coated for the first time and then coating the high viscosity resin.

The 6^{th} aspect of the present invention may be a method of manufacturing a multi-layered information recording medium according to any one of the 1^{st} aspect of the present invention through the 5^{th} aspect of the present invention, wherein a resin having a viscosity upon discharge at the ink jet head within a range from 5 mPa·s to 20 mPa·s is used as the stiffening resin.

By setting the range described above, the radiation-stiffening resin can be discharged stably in the ink jet head.

The 7^{th} aspect of the present invention may be a method of manufacturing a multi-layered information recording medium according to any one of the 1^{st} aspect of the present invention through the 6^{th} aspect of the present invention, wherein a (n+1)ₜₕ coating region of the stiffening resin stack-coated above the substrate is within an nₜₕ coating region, where n is a positive integer of 1 or greater.

With the constitution described above, in a case of coating from a radiation-stiffening resin of high viscosity, even when a resin at low viscosity to be stack-coated subsequently should flow, protrusion from the coating region can be suppressed. Further, in a case of coating from a radiation-stiffening resin of low viscosity, subsequent stack-coating can be conducted within a coating region for which good surface smoothness is obtained by a low viscosity resin coated previously, and good surface smoothness can be obtained.

The 8^{th} aspect of the present invention may be a method of manufacturing a multi-layered information recording medium according to any one of the 1^{st} aspect of the present invention through the 7^{th} aspect of the present invention, wherein a number of drops per unit area of a droplet of the stiffening resin dropping to the substrate is increased as the viscosity of the stiffening resin is increased.

The 9^{th} aspect of the present invention may be a method of manufacturing a multi-layered information recording medium according to any one of the 1^{st} aspect of the present invention through the 8^{th} aspect of the present invention, wherein a number of drops per unit area of the stiffening resin is set within a range from 180 dpi×180 dpi to 540 dpi×540 dpi.

The 10^{th} aspect of the present invention may be a method of manufacturing a multi-layered information recording medium according to any one of the 1^{st} aspect of the present invention through the 8^{th} aspect of the present invention, wherein a number of drops per unit area of the stiffening resin is set within a range from 180 dpi×180 dpi to 720 dpi×720 dpi.

The 11^{th} aspect of the present invention may be a method of manufacturing a multi-layered information recording medium according to any one of the 1^{st} aspect of the present invention through the 10^{th} aspect of the present invention, wherein coating is conducted in the ink jet coating step by a plurality of the ink jet heads each having an identical structure.

With the constitution described above, the structure of the apparatus is made simpler.

The 12^{th} aspect of the present invention may be a method of manufacturing a multi-layered information recording medium according to any one of the 1^{st} aspect of the present invention through the 11^{th} aspect of the present invention, wherein the stiffening resin is a radiation-stiffening resin.

The 13^{th} aspect of the present invention is an apparatus for manufacturing a multi-layered information recording medium for discharging a stiffening resin onto a substrate while relatively moving at least one of the substrate and an ink jet head, comprising:

a plurality of the ink jet heads provided for every different kind of the discharged stiffening resin,

wherein the stiffening resin is stack-coated to the substrate.

By the use of the apparatus, a plurality of radiation-stiffening resins of different viscosities can be stack-coated to attain a thick film.

The 14^{th} aspect of the present invention may be an apparatus for manufacturing a multi-layered information recording medium according to the 13^{th} aspect of the present invention, wherein a discharge width of the stiffening resin in the ink jet head is equal to or greater than a width of the substrate in a relation perpendicular to a running direction of the ink jet head.

The 15^{th} aspect of the present invention may be an apparatus for manufacturing a multi-layered information recording medium according to the 13^{th} aspect of the present invention or the 14^{th} aspect of the present invention, wherein a nozzle resolution of the ink jet head is within a range from 180 npi to 540 npi.

The 16^{th} aspect of the present invention may be an apparatus for manufacturing a multi-layered information recording medium according to the 13^{th} aspect of the present invention or the 14^{th} aspect of the present invention, wherein a nozzle resolution of the ink jet head is within a range from 180 npi to 720 npi.

The nozzle resolution means the number of nozzles per 1 inch and, for example, 180 npi means an ink jet head in which nozzles are arranged by the number of 180 per 1 inch length. Nozzles may be arranged in one row or may be arranged in plural rows.

The 17^{th} aspect of the present invention may be an apparatus for manufacturing a multi-layered information recording medium according to any one of the 13^{th} aspect of the present invention through the 16^{th} aspect of the present invention, wherein a plurality of the ink jet heads have each an identical structure.

The 18^{th} aspect of the present invention may be an apparatus for manufacturing a multi-layered information recording medium according to any one of the 13^{th} aspect of the present invention through the 18^{th} aspect of the present invention, wherein a (n+1)ₜₕ coating region of the stiffening resin stack-coated above the substrate is set within an nth coating region.

The 19^{th} aspect of the present invention may be an apparatus for manufacturing a multi-layered information recording medium according to any one of the 13^{th} aspect of the present invention through the 17^{th} aspect of the present invention, wherein the stiffening resin is a radiation-stiffening resin.

Thus, a multi-layered information recording medium having a resin intermediate layer of uniform thickness distribution and also excellent in the surface smoothness can be manufactured.

The 20^{th} aspect of the present invention may be a multi-layered information recording medium manufactured by using the method of manufacturing a multi-layered information recording medium according to any one of the 1^{st} aspect of the present invention through the 12^{th} aspect of the present invention.

According to the present invention, by stack-coating at least two kinds of radiation-stiffening resins of different viscosities by an ink jet coating method of discharging radiation-stiffening resins to a coating object while relatively moving at least one of the coating object and the ink jet head, a thick film resin layer, for example, of more than 10 μm can be formed, as well as a resin intermediate layer of uniform thickness distribution and excellent in the surface smoothness can be formed by utilizing the characteristics of such radiation-stiffening resins of different viscosities.

### BRIEF EXPLANATION OF DRAWINGS

FIG. 1(a) to (c) are views showing an example of coating and irradiation steps using an apparatus (inkjet coating apparatus) for manufacturing a multi-layered information recording medium in Embodiment 1 of the present invention.

FIG. 2(a) to (d) are views showing an example of a transfer step of an information surface to a resin intermediate layer in Embodiment 1 of the present invention.

FIG. 3(a) is a view for explaining a coating region at the first coating in Embodiment 1 of the present invention. FIG. 3(b) is a view for explaining a coating region at the second coating in Embodiment 1 of the present invention.

FIG. 4(a) to (c) are views for explaining an example of a nozzle arrangement of an ink jet head in Embodiment 1 of the present invention.

FIG. 5(a) to (b) are views showing a relation between a molded resin substrate and an ink jet nozzle unit in Embodiment 1 of the present invention.

FIG. 6 is a view for explaining the constitution of an ink jet head in Embodiment 1 of the present invention.

FIG. 7 is a cross sectional view showing an example of a structure of a multi-layered information recording medium in embodiment 3 of the present invention.

FIG. 8 is a cross sectional view of a 2-layered Blu-ray disk.

FIG. 9(a) to (f) are views showing existent manufacturing steps of a stamper.

FIG. 10(a) to (i) are views showing manufacturing steps of a 2-layered disk including manufacturing steps of a resin intermediate layer and a protection layer by using an existent spin coat method.

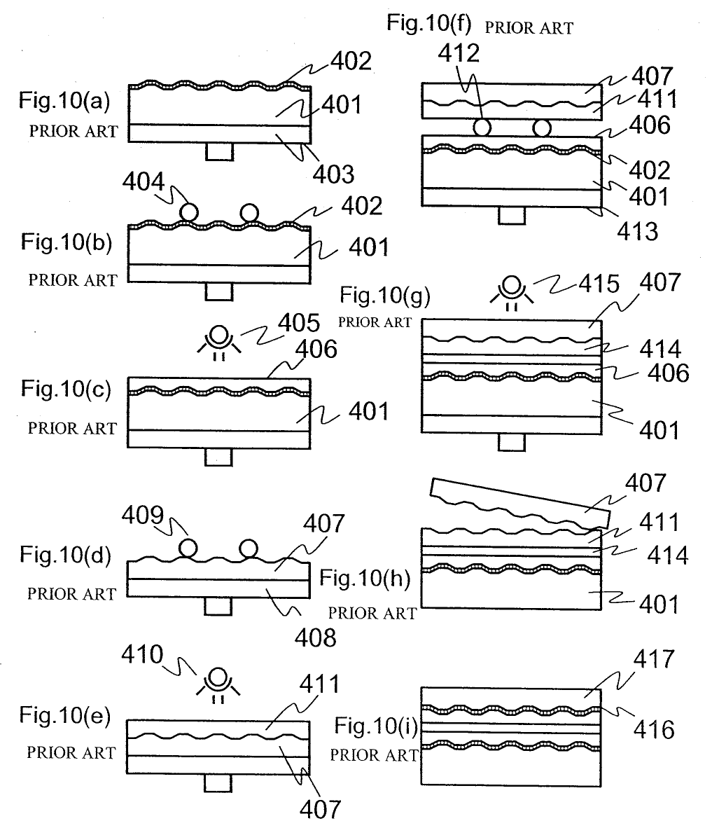

FIG. 11(a) to (b) are cross sectional views for a typical constitutional example of an ink jet nozzle.

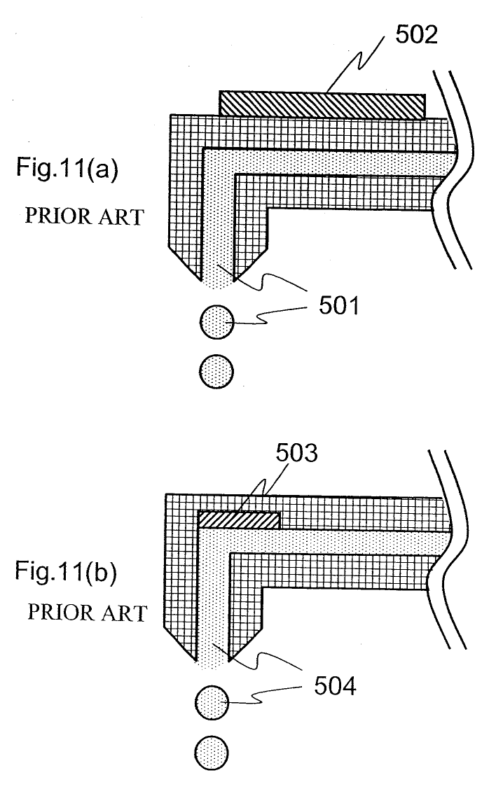

### DESCRIPTION FOR REFERENCE NUMERALS

101 molded resin substrate
102 first information layer
103 stage
104 ink jet head unit
105 ink jet head
106 ink jet head
107 fine droplet of a radiation-stiffening resin A
108 heater
109 heater
110 radiation ray irradiation device
111 fine droplet of a radiation-stiffening resin B
201 molded resin substrate
202 first information surface
203 first information layer
204 resin intermediate layer
205 second information surface
206 second information layer
207 protection layer
301 original plate
302 light sensitive film
303 exposure beam
304 exposure portion
305 concave/convex pattern
306 recording original plate
307 conductive thin film
308 metal plate
309 metal stamper
401 molded resin substrate
402 first information layer
403 rotational stage
404 radiation-stiffening resin C
405 radiation ray irradiator
406 resin layer
407 transfer stamper
408 rotational stage
409 radiation-stiffening resin D
410 radiation ray irradiator
411 resin layer
412 radiation-stiffening resin E
413 rotational stage
414 resin layer
415 radiation ray irradiator
416 second information layer
417 protection layer
501 discharge liquid
502 vibration device such as piezoelectric device
503 heater
504 discharge liquid
601 molded resin substrate
602 first information layer
603 first resin intermediate layer
604 second information layer
605 second resin intermediate layer
606 third information layer
607 third resin intermediate layer
608 fourth information layer
609 protection layer
701 molded resin substrate
702 information layer
703 radiation-stiffening resin
704 transfer stamper
705 center boss
706 pressure plate
707 vacuum chamber
708 vacuum pump
709 radiation ray irradiator
801 molded resin substrate
802 coated and irradiated region
803 ink jet head unit
804 ink jet head unit
901 ink jet nozzle
902 ink jet head
1001 ink jet nozzle
1002 ink jet head
1003 molded resin substrate
1101 molded resin substrate
1102 first coating region
1103 second coating region

### BEST MODE FOR CARRYING OUT THE INVENTION

Embodiments of the present invention are to be described below with reference to the drawings.

### Embodiment 1

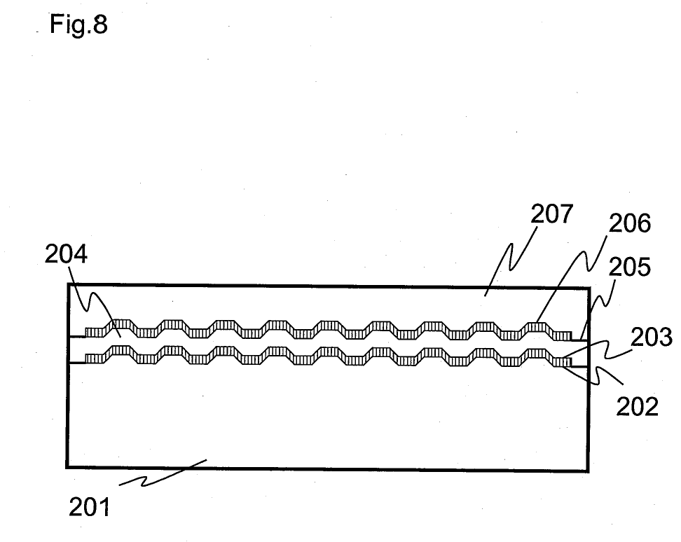

In the Embodiment 1, description is to be made for a manufacturing method of a two-layered information recording medium having two information layers as shown in FIG. 8 as an example.

On a molded resin substrate 201 having a first information surface 202 formed as a concave/convex shape on one side, a metal thin film or a thin film material capable of thermal recording is stacked, to form a first information layer 203.

A resin intermediate layer 204 substantially transparent to a recording or reproduction light is formed on the first information layer 203, and a second information surface 205 of a concave/convex shape is formed on the resin intermediate layer 204.

On the second information surface 205, a metal thin film translucent to the recording or reproduction light or a thin film material capable of thermal recording is stacked to form a second information layer 206.

Then, a resin substantially transparent to the recording or reproduction light is coated so as to cover the second information layer 206, to form a protection layer 207. Substantially transparent referred to herein means to have a transmittance of about 90% or higher to the recording or reproduction light. Further, translucent means to have a transmittance of 10% or higher and 90% or lower to the recording and reproduction light.

The 2-layered Blu-ray disk can record and reproduce signals by entering a laser light on the side of the protection layer 207 and focusing it to the information layer for conducting recording or reproduction in the first or second information layer.

It is set such that the thickness of the molded resin substrate 201 is about 1.1 mm, the thickness of the resin intermediate layer is about 25 μm, and the thickness of the protection layer 207 is about 75 μm.

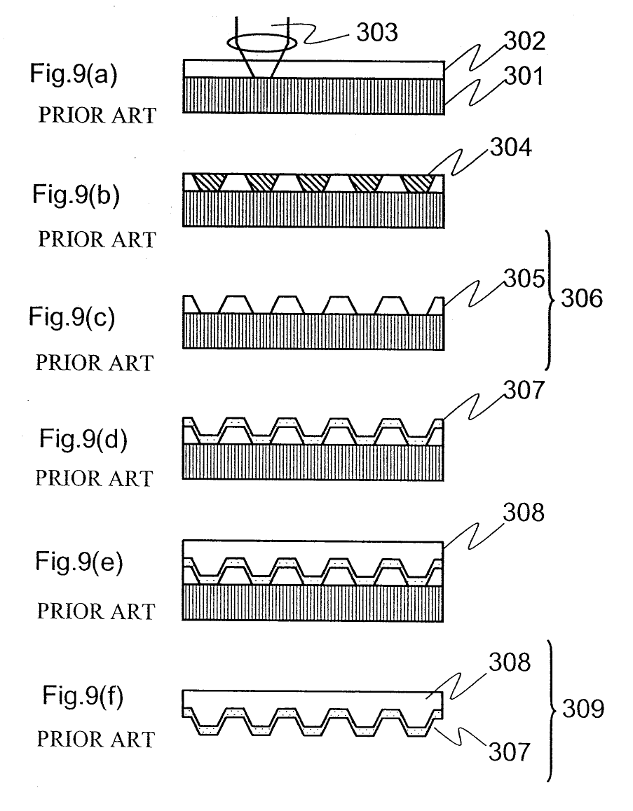

The molded resin substrate 201 is formed from a disk comprising a polycarbonate or acrylic resin having an outer diameter φ of 120 mm, a central hole diameter φ of 15 mm and a thickness of about 1.0 to 1.1 mm so as to have a configurational compatibility with an optical disk such as a CD or DVD and formed with an information surface such as guide grooves formed with concave/convex portion formed on one surface thereof by resin molding such as an injection molding method using a metal stamper shown in FIG. 9(f). In the Embodiment 1, it was manufactured by using a polycarbonate.

In a case where the information recording medium is a read only medium, it may suffice that the first information layer 203 has at least characteristics of reflecting a reproduction light and it is formed, for example, from a reflection material including Al, Ag, Au, Si, SiO₂, TiO₂, etc. by using a method such as sputtering or vapor deposition.

Further in a case where the information recording medium is a recordable medium, since it is necessary to write information by the irradiation of a recording light, it includes at least a layer comprising a phase change material such as GeSbTe or a recording material such as an organic dye, for example, phthalocyanine and may optionally include a layer for improving recording/reproduction characteristics such as a reflection layer and a boundary layer.

Also the second information layer 206, it can be formed in the same manner as described above. Since recording or reproduction is conducted by entering a recoding or reproduction light to respective information layers on the side of the protection layer 207, it is constituted such that the second information layer 206 has a higher transmittance to the wavelength of the recording or reproduction light relative to the first information layer 203.

Further, the resin intermediate layer 204 is substantially transparent to the recording or reproduction light and, for example, a UV-ray stiffening resin mainly comprising an acrylic component, or a radiation-stiffening resin such as an epoxy type UV ray-stiffening resin can be used.

Substantially transparent referred to herein means to have a transmittance of 90% or higher to the wavelength of the recording or reproduction light and a material having a transmittance of 95% or higher is preferred.

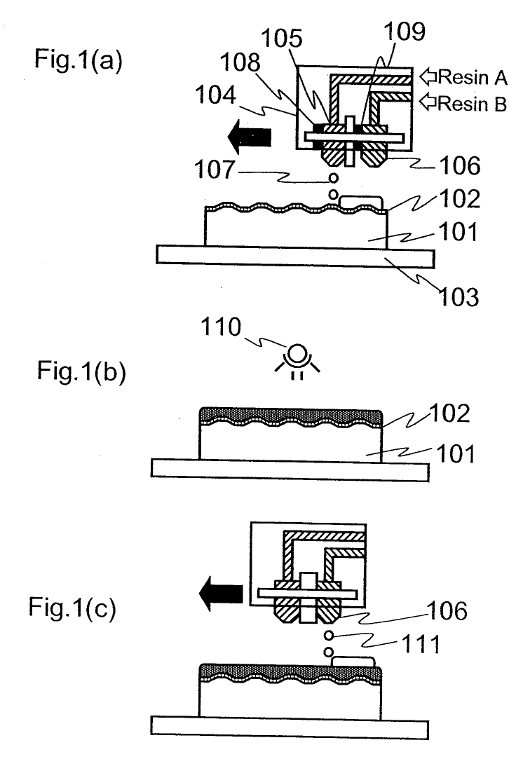

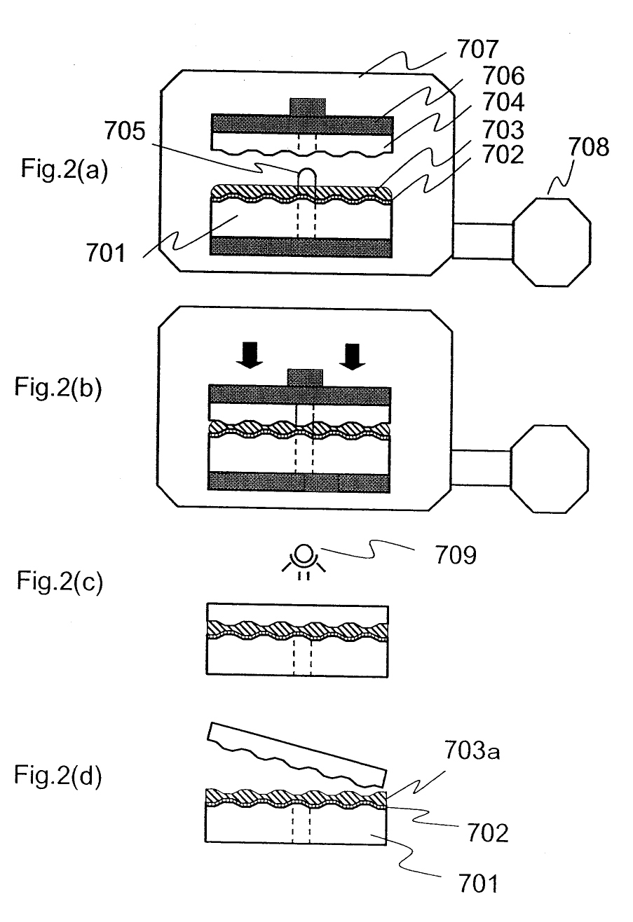

The manufacturing method of the resin intermediate layer 204 includes a step of coating a liquid radiation-stiffening resin on the first information layer 203 by using an ink jet coating method to be described later (refer to FIG. 1(a) to FIG. 1(c)) and a step of transferring the information surface to the radiation-stiffening resin by utilizing a transfer stamper having an information surface such as pits or guide grooves (refer to FIG. 2(a) to FIG. 2(d)).

FIG. 2 is a view showing an example of transfer step of an information surface to the resin intermediate layer in the Embodiment 1 of the present invention.

A molded resin substrate 701 after completing coating of the radiation-stiffening resin 703 on an information layer 702 by using an ink jet coating method of the present invention is transported into a vacuum chamber 707. In this step, a transfer stamper 704 is also disposed in the vacuum chamber 707 (refer to FIG. 2(a)).

For the transfer stamper 704, a polyolefin material which is a material having good releasability from the radiation-stiffening resin is used and it is formed to a thickness less than that of the molded resin substrate, for example, to 0.6 mm. This is because it intends to warp and separate the transfer stamper upon peeling the transfer stamper from the molded resin substrate at a thickness, for example, of about 1.1 mm by utilizing the difference of rigidity due to the difference of the thickness of the substrate.

The polyolefin material is a material capable of easily preparing an information surface such as pits or guide grooves of the concave/convex portions on one side by a method, for example, an injection molding by using an existent metal stamper, etc. in the same manner as the molded resin substrate. Further, since the polyolefin material also has high transmittance to radiation rays such as UV-rays, the radiation-stiffening resin can be cured efficiently by irradiating radiation rays through the transfer stamper and it has low adhesion with the cured radiation-stiffening resin and can be peeled easily from the boundary with the radiation-stiffening resin after curing.

At the center of the transfer stamper 704, a central hole is formed for preventing eccentricity by way of the molded resin substrate 701 and the center boss 705.

The inside of the vacuum chamber 707 is evacuated by a vacuum pump 708 such as a rotary pump or a turbo molecular pump and put to a vacuum atmosphere in a short time.

In the Embodiment 1 of the present invention, when the pressure in the vacuum chamber 707 reaches a vacuum degree of 100 Pa or lower, the transfer stamper 704 is stacked to the molded resin substrate 701 (refer to FIG. 2(b)). In this case, the pressure plate 706 disposed above the transfer stamper 704 presses the transfer stamper 704 to transfer the information surface on the transfer stamper to the radiation-ray stiffening resin 703.

Since the inside of the vacuum chamber is in a vacuum atmosphere, the radiation-stiffening resin 703 and the transfer stamper 704 can be bonded with each other with no intrusion of bubbles therebetween. The molded resin substrate 701 and the transfer stamper 704 bonded to each other are irradiated with radiation rays through the transfer stamper 704 by a radiation ray irradiator 709 at the inside of the vacuum chamber or after being taken out therefrom (FIG. 2(c)).

Then, the transfer stamper is peeled from the boundary between the radiation-stiffening resin and the transfer stamper, for example, by spiking a wedge or blowing pressurized air between the transfer stamper and the molded resin substrate (refer to FIG. 2(d)).

As described above, a first resin intermediate layer 703a transferred with the information surface (corresponding to the resin intermediate layer 204 in FIG. 8) is formed. In addition to that described herein, while there are various methods of transferring the information surface to the radiation-stiffening resin, for example, by using a different material such as a metal as a transfer stamper or irradiating radiation rays on the side of the molded resin substrate, the effect of the present invention is not restricted also in a case of using any of them.

Further, the protection layer 207 (refer to FIG. 8) is substantially transparent to the recording or reproduction light and, for example, a UV-ray stiffening resin mainly comprising an acrylic component, or a radiation-stiffening resin such as an epoxy type UV-ray stiffening resin can be used therefor.

Substantially transparent referred to herein means to have a transmittance of 90% or higher to the wavelength of the recording or reproduction light and a material having a transmittance of 95% or higher is more preferred.

As the method of forming the protection layer 207, various methods are considered such as a spin coat method, a screen printing method, a gravure printing method, and an ink jet method of the present invention.

As the method of forming the protection layer 207, it is most preferred that the same method as the manufacturing step for the resin intermediate layer can be used and it is most preferred to use an ink jet method also for the preparation of the protection layer in a case of coating the resin intermediate layer, for example, by the ink jet method of the present invention.

Further, as the method of forming the protection layer, it may be formed not only by coating the radiation-stiffening resin but may be formed also by bonding a sheet-like material, for example, comprising a polycarbonate resin or an acryl resin to each other by way of an adhesive.

Further, the multi-layered information recording medium in the Embodiment 1 of the present invention conducts recording or reproduction by using a blue-purple laser as a laser beam at 405 nm, and restricting the beam to each of the information layers on the side of the protection layer 207 by using an objective lens having NA of 0.85. For mitigating the effect by the tilt of the disk, the thickness from the surface of the protection layer 207 to the first information layer 203 is set to about 0.1 mm.

However, the desired value for the thickness of the resin intermediate layer is an example and the effect of the present invention does not change also at other designed value of the thickness.

While description has been made simply to the outline for the constitution and the manufacturing method of the multi-layered information recording medium in the Embodiment 1 of the present invention, the method of manufacturing the multi-layered information recording medium of the present invention has a feature in the method of forming the resin intermediate layer or the protection layer and, accordingly, the range of the present invention is not restricted by other constitution or manufacturing method thereof.

In the followings, description is to be made specifically mainly for the method of manufacturing the multi-layered information recording medium in the Embodiment 1 of the present invention, particularly for the manufacturing method of the resin intermediate layer.

FIG. 1(a) to FIG. 1(c) are views showing an example of the coating step for a radiation-stiffening resin using an apparatus for manufacturing a multi-layered information recording medium in the Embodiment 1 of the present invention (ink jet coating apparatus).

At first, as shown in FIG. 1(a), a molded resin substrate 101 formed with a first information layer 102 on one side is fixed to a stage 103, for example, by vacuum suction. Above the molded resin substrate 101, an ink jet head unit 104 comprising at least two ink jet heads is arranged.

The stage 103 and the ink jet head unit 104 are made movable relative to each other. Description is to be made herein for the method of fixing the stage 103 and moving the ink jet head unit 104 in parallel to conduct coating. However, it may suffice that the stage 103 and the ink jet head unit 104 are moved relatively, and the stage 103 may be moved conversely in parallel or both of them may be moved together.

While relatively moving the ink jet head unit 104 in parallel to the stage 103, a radiation-stiffening resin A (107) formed as a fine droplet is dropped from one ink jet head 105 onto the molded resin substrate 101.

Further, heaters 108, 109 are disposed to the ink jet heads 105, 106 respectively and they are adapted so as to heat the resin in the ink jet head and lower the viscosity of the resin independent of each other.

After coating the radiation-stiffening resin A (107) to the coating region on the molded substrate 101, the stage 103 is moved to a position below the radiation-ray irradiation device 110, radiation rays are irradiated and the coated radiation-stiffening resin A (107) is cured (refer to FIG. 1(b)).

As the radiation irradiation device, a UV-ray lamp was used herein. As the UV-ray lamp, while there are various lamps such as a metal halide lamp, a high pressure mercury lamp or a xenon lamp, the xenon lamp was used herein. However, it is necessary to select the wavelength of radiation rays to be irradiated in accordance with the radiation-stiffening resin used for the coating, and the type of the lamp is not restricted only thereto.

Further, while the region irradiated by the radiation rays may be cured completely, flow of the resin can be suppressed when it is not cured completely but cured to a state similar therewith. The state similar to complete cure means a state in which it is in a gel form or has a viscosity of 10,000 mPa·s or more.

Then, the stage 103 is moved again to a position below the ink jet head unit 104 and a radiation-stiffening resin B 111 of a viscosity different from that of the radiation-stiffening resin A 107 is dropped and coated on the coated region of the cured radiation-stiffening resin A by using another ink jet head 106 (refer to Fig. (c)).

As described above, ink jet heads are disposed on every radiation stiffening resin of different viscosity to conduct stack-coating.

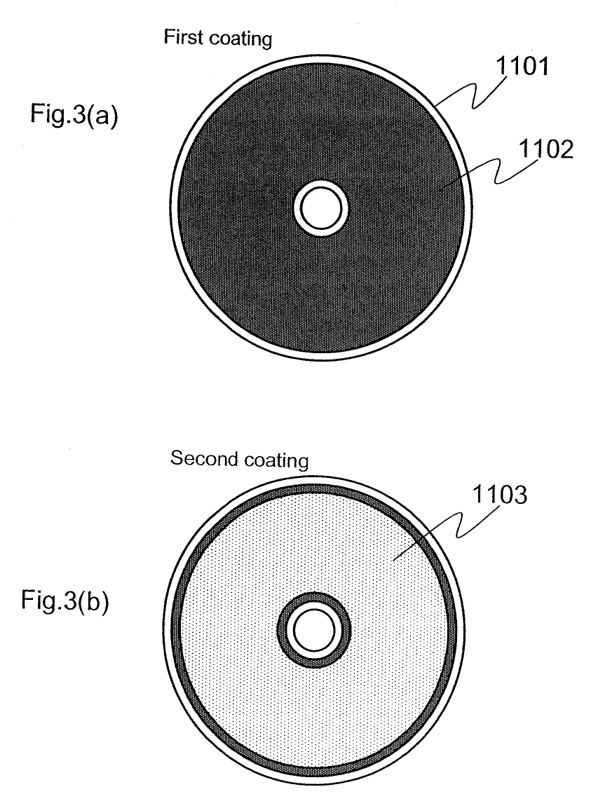

Further, in such a stack-coating, as shown in FIG. 3(a) and FIG. 3(b), the coating region of the radiation-stiffening resin coated on the molded resin substrate 110 is to satisfy the following condition. That is, the coating region 1103 to be coated subsequently is coated such that it is contained inside the coating region 1102 coated previously.

The reason is that the fluidity of the resin on the coated surface is higher in a case of stack-coating the radiation-stiffening resin on the cured radiation-stiffening resin than in a case of coating a radiation-stiffening resin on the molded resin substrate or the information layer. That is, in a case of coating the resin to be coated subsequently to a region of a size equal with or larger than the coating region of the previously coated resin, the subsequently coated region protrudes out of the desired coating region to cause fluctuation in the thickness.

Also in a case where the number of stack-coating is three times or more, it is also preferred to conduct coating within the previously coated coating region.

Further, while description is to be made with reference to the two kinds of radiation-stiffening resins, there is no problem of using three or more kinds of radiation-stiffening resins. In a case of using three or more kinds of radiation-stiffening resins, individual ink jet heads may be provided by the number of the kinds of resins to be used.

In a case where the resins are of an identical kind, the ink jet head may be one, or the ink jet head may be disposed individually on every different viscosity. This is because, the viscosity can be changed by utilizing the heater disposed near the discharge port of the ink jet head also in a case of the constitution for one ink jet head.

However, for shortening the coating time (tact time), it is preferred to provide the ink jet heads individually by the number of the kinds of the viscosities even for the identical resin. This is because coating for plurality layers can be conducted rapidly without waiting for the temperature increase by the heater. Further, in a case where the kinds of the resin are different, the ink jet heads may preferably be provided individually such that respective resins are not mixed.

By repeating the coating steps in FIG. 1(a) to FIG. 1(c) described above, the resin can be stack-coated and a thick film of a desired thickness can be formed.

In a case of preparing the resin intermediate layer, since the transfer step of the information surface to the resin intermediate layer (refer to FIG. 2(b), FIG. 2(c)) is disposed subsequent to the coating step (refer to FIG. 1(a) to FIG. 1(c)) as described previously, the radiation-stiffening resin layer coated at the last of the coating step is sent to the transfer step for the information surface described with reference to FIG. 2 without curing or being cured to such an extent as capable of transferring the information surface (FIG. 2(b), FIG. 2(c)).

In a case where the coating step corresponds to the preparation step for the protection layer, since it is not necessary to conduct the transfer step for the information layer, the last coated radiation-stiffening resin layer is cured completely.

Then, the constitution of the ink jet heads 105, 106 is to be described.

In the ink jet head 105, 106, at least one ink jet nozzle is disposed. Generally ink jet nozzle is such one as used in a printing or drawing printing press. While the ink jet nozzle can discharge fine droplets of an ink comprising a pigment or dye as a main ingredient, such an ink jet technique has been developed in the direction of preparing droplets as fine as possible, for example, droplets of about several pL, and dropping them at a high accuracy thereby attaining printing of higher resolution.

However, since it is necessary in the present invention to form a relatively thick resin layer, for example, of 10 μm or more, it is preferred to use an ink jet nozzle capable of discharging droplets as large as possible. For example, it is preferred to use an ink jet nozzle capable of discharging a large droplet, for example, of about several tens pL. Ink jet nozzles for printing press generally available at present include those for fine droplets with a volume of about 5 to 50 pL, viscosity of dischargeable resin of about 5 to 20 mPa·s at the periphery of the discharge portion and an operation frequency of about 1 kHz to 20 kHz.

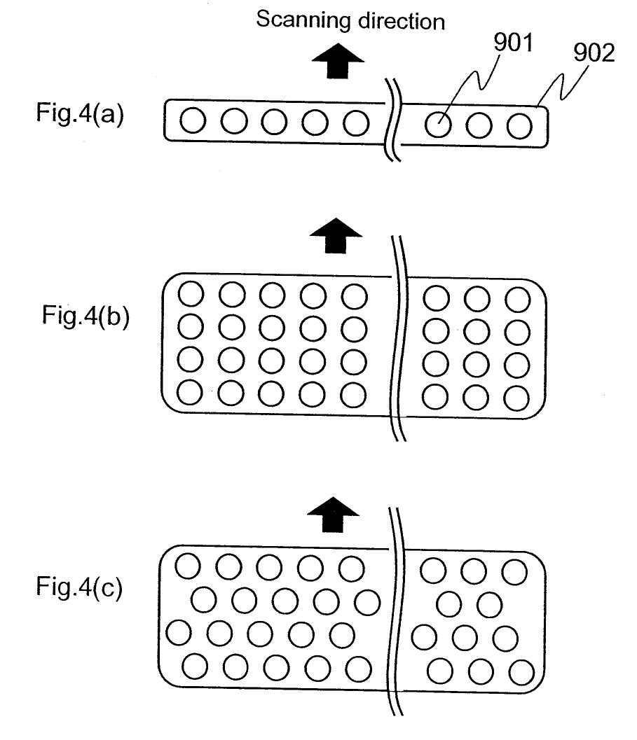

Further, while an ink jet head using one ink jet nozzle may also be considered, since it is relatively easy to provide ink jet nozzles in plurality, there is a constitution of arranging them in one row along a direction perpendicular to the scanning direction for ink jet heads to provide a row of ink jet head, for example, as shown in FIG. 4(a). Alternatively, there is a method of arranging them further in plural rows in the scanning direction as shown in FIG. 4(b) or a method of arranging them in plural rows while displacing the position for nozzles 901 little by little as shown in FIG. 4(c).

The constitution of the nozzle in the ink jet head can be represented by an index referred to as a nozzle resolution. The nozzle resolution means the number of nozzles arranged per unit length and the number of nozzles per 1 inch can be expressed, for example, by the unit npi (nozzle per inch).

In the Embodiment 1 of the present invention, an ink jet head of an identical structure was used for the ink jet heads 105, 106, and an ink jet head of a nozzle resolution of 540 npi was used. Although the ink jet heads of an identical structure may not be used, use of the ink jet heads of the identical structure can provide an apparatus of a simpler constitution since it is not necessary to provide individual ink jet head on every resin.

In the Embodiment 1 of the present invention, it is desired for such a constitution that the nozzles are arranged linearly by at least one row in the direction perpendicular to the scanning direction of the ink jet heads for a width of 120 mm or more such that the length of 120 mm for the diameter of the molded resin substrate 101 as an object for coating can be coated at once.

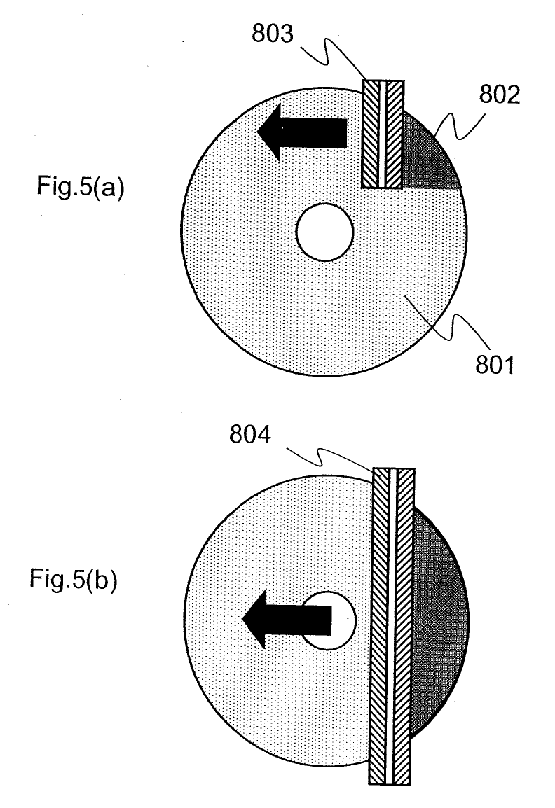

As shown in FIG. 5(a), it is also possible to coat by an ink jet head 803 with a narrower discharge width than the length of the coating object in the direction perpendicular to the scanning direction of the ink jet head (120 mm for the diameter of the molded resin substrate 801 as the coating object in this case).

However, in this case, the coating resin cannot be coated by the running of ink jet head for once, and coating is conducted by scanning the ink jet head on the substrate for several times while displacing the ink jet head by the width of the ink jet head. Accordingly, a thickness distribution is caused to respective joints between the coated coating regions, or splashes, etc. of the subsequently coated resin are scattered to the previously coated coating region and this is not preferred.

Accordingly, as shown in FIG. 5(b), it is preferred for the constitution that the ink jet head 804 is longer than the diameter of the molded resin substrate 801.

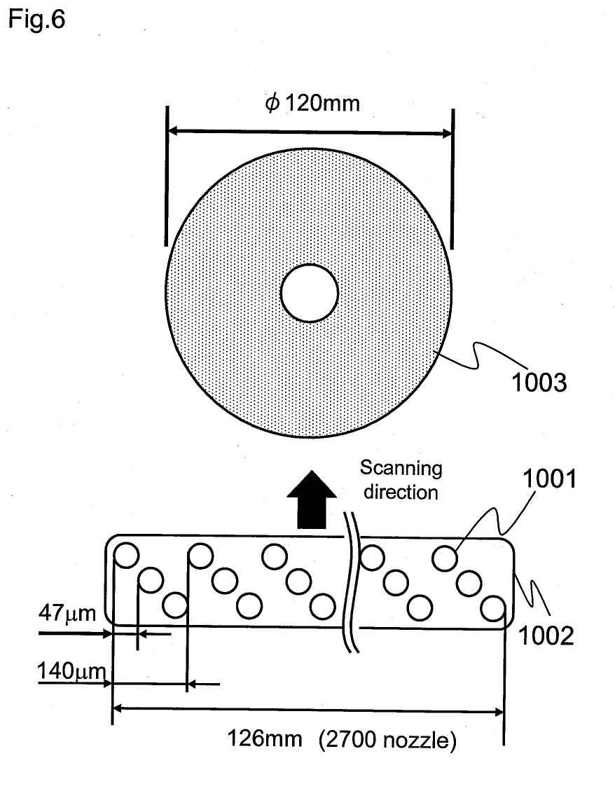

Then, the ink jet coating apparatus in the Embodiment 1 of the present invention used an ink jet head 1002, using an ink jet nozzle having a discharging amount for one drop of 40 pL and a driving frequency of 7 kHz, arranging ink jet nozzles 1001 by the number of 900 linearly in the direction perpendicular to the scanning direction at a pitch of 140 μm in three rows while displacing the ink jet nozzle rows each by 47 μm as shown in FIG. 6, and disposing the nozzles by the number of 2700 for the ink jet head length of 126 mm.

The constitution of the ink jet head corresponds to the nozzle resolution of 540 npi. Resin discharge can be controlled selectively for each one of ink jet nozzles and, in a case where the resin is discharged by using all nozzles, the resin can be discharged at a resolution of 540 dpi (dot per inch). For example, in a case of dropping the resin by using only the nozzles by the number of 900 arranged in one raw, the resin is dropped at a resolution of 180 dpi. As described above, the resolution of the dropping resin can be set optionally.

Dropping of the resin at the resolution of 180 dpi means that the number of drops per unit area of the resin is 180 dpi×180 dpi. In the same manner, dropping of the resin at the resolution of 540 dpi means that the number of drops per unit area of the resin is 540 dpi×540 dpi.

Further, the ink jet nozzle can stably discharge one drop of 40 pL so long as the resin has a viscosity of about 5 to 20 mPa·s.

Then, by using the ink jet coating apparatus, a resin intermediate layer was prepared by using a plurality kinds of resins and physical properties were evaluated. Table 1 shows the result of measurement in a case of conducting stack-coating twice thereby preparing resin intermediate layers of 25 μm thickness.

TABLE 1

| | | | | | | | | | Variation | | | |
|---|---|---|---|---|---|---|---|---|---|---|---|---|
| | | | Viscosity (mPa · s) | | | Heater | | Coating | of | | Focus residue | |
| | Coating | | at | at | upon | heating | Resolution | thickness | thickness | Resin | (nm) | |
| Condition | order | Resin | 20° C. | 50° C. | discharge | (50° C.) | (dpi) | (μm) | (μm) | protrusion | 1.8 kHz-10 kHz | 10 kHz- |
| 1-1 | 1 | R1 | 180 | 20 | 20 | yes | 540 | 25.3 | ±1.8 Δ | ◯ | 22 ◯ | 33 X |
| | 2 | R1 | 180 | 20 | 20 | none | 180 | | | | | |
| 1-2 | 1 | R1 | 180 | 20 | 20 | yes | 540 | 24.9 | ±1.2 ◯ | ◯ | 10 ◯ | 15 ◯ |
| | 2 | R2 | 16 | — | 16 | none | 180 | | | | | |
| 1-3 | 1 | R1 | 180 | 20 | 20 | yes | 540 | 24.6 | ±1.4 ◯ | ◯ | 11 ◯ | 11 ◯ |
| | 2 | R3 | 10 | — | 10 | none | 180 | | | | | |
| 1-4 | 1 | R1 | 180 | 20 | 20 | yes | 540 | 24.2 | ±1.5 ◯ | ◯ | 12 ◯ | 10 ◯ |
| | 2 | R4 | 5 | — | 5 | none | 180 | | | | | |
| 1-5 | 1 | R1 | 180 | 20 | 20 | yes | 540 | 23.9 | ±2.2 X | X | 15 ◯ | 17 ◯ |
| | 2 | R5 | 3 | — | 3 | none | 180 | | | | | |

The average value for the thickness, variation of the thickness over the entire coating region, and protrusion of the resin from the desired coating region were evaluated when the viscosity of the resin and the coating resolution used as conditions were changed.

In the measurement for the thickness of the resin intermediate layer, the beam was restricted by a lens using a laser at a wavelength of 405 nm as a light source, and focusing it to the information layer formed to the surface of the resin intermediate layer or the surface of the molded resin substrate while moving the lens by an actuator, and evaluation was made by using a thickness measuring instrument for measuring the thickness based on the driving amount of the actuator.

Further, the variation in the thickness is represented as the variation of the thickness over the entire area of the coating region with the average value of the thickness being as a center and the necessary thickness variation is within ±2 μm as the performance of the disk. Further, variation within ±1.5 μm is more preferred.

Further, the focus residue was evaluated by forming as far as the protection layer and then evaluating electric signals of the second information layer by using a disk evaluation machine DDU-1000 manufactured by Pulstec Industrial Co. Ltd. The reproduction linear velocity was set to 4.9 m/s with the specification of a Blu-ray disk as a reference and the residual component was evaluated in two frequency regions of a band from 1.8 kHz to 10 kHz and a band of 10 kHz or higher.

The value of the focus residue depends on the smoothness on the surface of the information layer and, as the surface smoothness was worsened, a component that the focus control of an optical pick-up cannot follow develops as a residual component. Respective aimed values are ±45 nm or less in the band of 1.8 kHz to 10 kHz and 32 nm or less in the band of 10 kHz or more.

Further, protrusion of the resin was evaluated on the coating region set for the resin intermediate layer by observation at the end face of the resin layer by an optical microscope as to whether the resin protrudes to the outside of the region or not.

In the Embodiment 1, coating was conducted while setting, as the coating region, a doughnut-like region having a 23 mm inner diameter and a 118 mm outer diameter for the first coating and a setting doughnut-like region having a 23.2 mm inner diameter and a 117.8 mm outer diameter for the second coating. It was determined as a reference of evaluation as to whether the resin protruded out of the region of a 118.6 mm outer diameter by an optical microscope. However, the coating region set in the Embodiment 1 is an example and there is no problem when using other setting for the coating region.

Further, also for the evaluation reference determined herein, other evaluation reference may be used so long as it does not protrude out of the molded resin substrate of 120 mm diameter.

Further, as the coating resolution, 540 dpi was selected at the first coating. This is because a distance between adjacent droplets was narrowed whereby the effects of intrusion of bubbles and splashes increased remarkably when the dot pitch was made finer than 540 dpi in an ink jet nozzle capable of discharging a droplet of about 40 pL which is used for enabling thick film coating and the highest resolution not undergoing the effect of the intrusion of bubbles was selected for coating a thick film.

Further, in a case where the dot pitch is made coarser on the contrary, since the distance between adjacent droplets was widened, uniformity of the thickness and the smoothness on the surface are worsened. The effect is different depending, for example, on the viscosity of the resin to be used and even a low viscosity resin of about 5 mPa·s usable with a view point of the variation in thickness as shown in Table 1 could not be used at a dot pitch coarser than 180 dpi since this caused a problem for the smoothness on the surface.

In view of the result of Table 1, in a case where a resin material R1 having a resin viscosity at a temperature of 20° C. of 180 mPa·s was coated twice in stack as in the condition (1-1) shown in Table 1, while there was no problem regarding protrusion and thickness distribution of the resin, undulation on the surface depending on the pattern of the droplet resulted increase of the focus residue.

On the contrary, by lowering the resin viscosity of the resin material coated at the second time as in condition (1-2) to condition (1-5), undulation on the surface caused by the first coating was smooth by the low viscosity resin coated at the second time and the surface undulation was improved and the focus residue also reached the aimed value.

The reason of selecting a low resolution of 180 dpi in the second coating as shown in Table 1 is to prevent protrusion of the resin.

Further, when the resin viscosity increased to 20 mPa·s or more, discharge from the ink jet head was difficult.

Further, in view of the result of Table 1, by stack-coating plural kinds of resins of different viscosities, thickness within a range of ±1 μm relative to an aimed thickness of 25 μm (24 μm to 26 μm) could be attained under the conditions from (1-1) to (1-4). However, under the condition (1-5), the coating thickness was 23.9 μm which was out of the range of 24 μm to 26 μm.

Further, Table 2 shows the result of coating using an ink jet head of high nozzle resolution.

TABLE 2

| | | | | | | | | | Variation | | | |
|---|---|---|---|---|---|---|---|---|---|---|---|---|
| | | | Viscosity (mPa · s) | | | Heater | | Coating | of | | Focus residue | |
| | Coating | | at | at | upon | heating | Resolution | thickness | thickness | Resin | (nm) | |
| Condition | order | Resin | 20° C. | 50° C. | discharge | (50° C.) | (dpi) | (μm) | (μm) | protrusion | 1.8 kHz-10 kHz | 10 kHz- |
| 1-6 | 1 | R1 | 180 | 20 | 20 | yes | 720 | 26.0 | ±1.9 Δ | ◯ | 25 ◯ | 35 X |
| | 2 | R1 | 180 | 20 | 20 | none | 180 | | | | | |
| 1-7 | 1 | R1 | 180 | 20 | 20 | yes | 720 | 25.6 | ±1.4 ◯ | ◯ | 13 ◯ | 17 ◯ |
| | 2 | R2 | 16 | — | 16 | none | 180 | | | | | |
| 1-8 | 1 | R1 | 180 | 20 | 20 | yes | 720 | 25.4 | ±1.4 ◯ | ◯ | 12 ◯ | 12 ◯ |
| | 2 | R3 | 10 | — | 10 | none | 180 | | | | | |
| 1-9 | 1 | R1 | 180 | 20 | 20 | yes | 720 | 24.9 | ±1.5 ◯ | ◯ | 13 ◯ | 12 ◯ |
| | 2 | R4 | 5 | — | 5 | none | 180 | | | | | |
| 1-10 | 1 | R1 | 180 | 20 | 20 | yes | 720 | 24.4 | ±2.4 X | X | 18 ◯ | 18 ◯ |
| | 2 | R5 | 3 | — | 3 | none | 180 | | | | | |

An ink jet head capable of selecting the nozzle resolution up to 720 dpi was used and the amount of droplet per one drop was adjusted to about 30 pL by changing the resin discharge condition.

When the nozzle resolution was increased to 720 dpi, while the effect of splash or the like developed somewhat compared to the case of using a head of the nozzle resolution of 540 dpi, the effect was mitigated in the subsequent transfer step of the information surface and there was no particular problem in view of the performance of the disk.

### Embodiment 2

In Embodiment 2, description is to be made to a method of manufacturing a 2-layered information recording medium having two information layers as shown in FIG. 8 as an example in the same manner as explained for the Embodiment 1.

Since other steps except for the coating step of the resin intermediate layer are quite identical with the steps explained for the Embodiment 1, description therefor is to be omitted.

Further, the present invention concerns a step of preparing the resin intermediate layer and other step may be any step.

Further, also in the Embodiment 2, in the coating region of the radiation-stiffening resin coated above the molded resin substrate 1101, a coating region 1103 coated subsequently is coated within a coating region 1102 coated previously as shown in FIG. 3(a) and FIG. 3(b).

This is because the fluidity of a resin at the coating surface is higher in a case of coating a radiation-stiffening resin in stack on a cured radiation-stiffening resin than in a case of coating the radiation-stiffening resin on a molded resin substrate or an information layer. That is, when the resin coated subsequently is coated to a region for a size identical with or larger than the coating region of the previously coated resin, the subsequently coated resin protrudes to the outside of the desired coating region to cause variation in the thickness or the like. Also in a case where the number of times for stacked coating is three times or more, it is preferred to conduct coating within the previously coated coating region.

In the Embodiment 2, coating was conducted while setting, as the coating region, a doughnut-like region having a 23 mm inner diameter and a 118 mm outer diameter for the first coating and a doughnut-like region having a 23.2 mm inner diameter and a 117.8 mm outer diameter for a the second coating. It was determined as a reference of evaluation as to whether the resin protruded out of the region of a 118.6 mm outer diameter by an optical microscope. However, the coating region set in the Embodiment 1 is an example and there is no problem when using other setting for the coating region. Further, also for the evaluation reference determined herein, other evaluation reference may be used so long as it does not protrude out of the molded resin substrate of 120 mm diameter.

Coating was conducted by using an apparatus of the constitution identical with that of the ink jet coating apparatus explained for the Embodiment 1. Table 3 shows the result of the evaluation.

TABLE 3

| | | | | | | | | | Variation | | | |
|---|---|---|---|---|---|---|---|---|---|---|---|---|
| | | | Viscosity (mPa · s) | | | Heater | | Coating | of | | Focus residue | |
| | Coating | | at | at | upon | heating | Resolution | thickness | thickness | Resin | (nm) | |
| Condition | order | Resin | 20° C. | 50° C. | discharge | (50° C.) | (dpi) | (μm) | (μm) | protrusion | 1.8 kHz-10 kHz | 10 kHz- |
| 2-1 | 1 | R2 | 16 | — | 16 | none | 180 | 25.4 | ±1.8 Δ | ◯ | 25 ◯ | 30 Δ |
| | 2 | R1 | 180 | 20 | 20 | yes | 540 | | | | | |
| 2-2 | 1 | R3 | 10 | — | 10 | none | 180 | 25.1 | ±1.5 ◯ | ◯ | 13 ◯ | 17 ◯ |
| | 2 | R1 | 180 | 20 | 20 | yes | 540 | | | | | |
| 2-3 | 1 | R4 | 5 | — | 5 | none | 180 | 24.8 | ±1.7 Δ | ◯ | 15 ◯ | 15 ◯ |
| | 2 | R1 | 180 | 20 | 20 | yes | 540 | | | | | |
| 2-4 | 1 | R5 | 3 | — | 3 | none | 180 | 24.3 | ±2.5 X | Δ | 13 ◯ | 12 ◯ |
| | 2 | R1 | 180 | 20 | 20 | yes | 540 | | | | | |

In the Embodiment 2, different from the Embodiment 1, coating was conducted from the resin of low viscosity. By using the constitution, undulation on the surface of the information layer could be smoothed by the low viscosity resin coated for the first time and, even when a high viscosity resin was coated at the second time, the focus residue was not worsened greatly and a good result was obtained.

Further, by stack-coating two kinds of resins of different viscosities, thickness within a range of ±1 μm could be attained relative to the aimed thickness of 25 μm under the conditions (2-1) to (2-4) shown in Table 3.

Further, under the condition (2-4), variation in the thickness was ±2.5 μm which exceeded the aimed ±2 μm. This is attributable to that the resin R5 coated at the first time flowed to worsen the uniformity of the thickness. In a case of using a resin at a viscosity of 5 mPa·s or more, there was no problem also for the uniformity of the thickness.

Further, Table 4 shows the result of coating using an ink jet head of high nozzle resolution.

TABLE 4

| | | | | | | | | | Variation | | | |
|---|---|---|---|---|---|---|---|---|---|---|---|---|
| | | | Viscosity (mPa · s) | | | Heater | | Coating | of | | Focus residue | |
| | Coating | | at | at | upon | heating | Resolution | thickness | thickness | Resin | (nm) | |
| Condition | order | Resin | 20° C. | 50° C. | discharge | (50° C.) | (dpi) | (μm) | (μm) | protrusion | 1.8 kHz-10 kHz | 10 kHz- |
| 2-5 | 1 | R2 | 16 | — | 16 | none | 180 | 25.7 | ±1.9 Δ | ◯ | 28 ◯ | 38 X |
| | 2 | R1 | 180 | 20 | 20 | yes | 720 | | | | | |
| 2-6 | 1 | R3 | 10 | — | 10 | none | 180 | 25.5 | ±1.5 ◯ | ◯ | 14 ◯ | 18 ◯ |
| | 2 | R1 | 180 | 20 | 20 | yes | 720 | | | | | |
| 2-7 | 1 | R4 | 5 | — | 5 | none | 180 | 24.9 | ±1.9 Δ | ◯ | 17 ◯ | 17 ◯ |
| | 2 | R1 | 180 | 20 | 20 | yes | 720 | | | | | |
| 2-8 | 1 | R5 | 3 | — | 3 | none | 180 | 24.6 | ±2.8 X | Δ | 15 ◯ | 15 ◯ |
| | 2 | R1 | 180 | 20 | 20 | yes | 720 | | | | | |

An ink jet head capable of selecting the nozzle resolution up to 720 dpi was used and the amount of droplet per one drop was adjusted to about 30 pL by changing the resin discharge condition.

When the nozzle resolution was increased to 720 dpi, while the effect of splash or the like developed somewhat compared to the case of using a head of the nozzle resolution of 540 dpi, the effect was mitigated in the subsequent transfer step of the information surface and there was no particular problem in view of the performance of the disk.

Dropping of the resin at the resolution of 720 dpi means that the number of dropping per unit area of the resin is 720 dpi×720 dpi.

### Embodiment 3

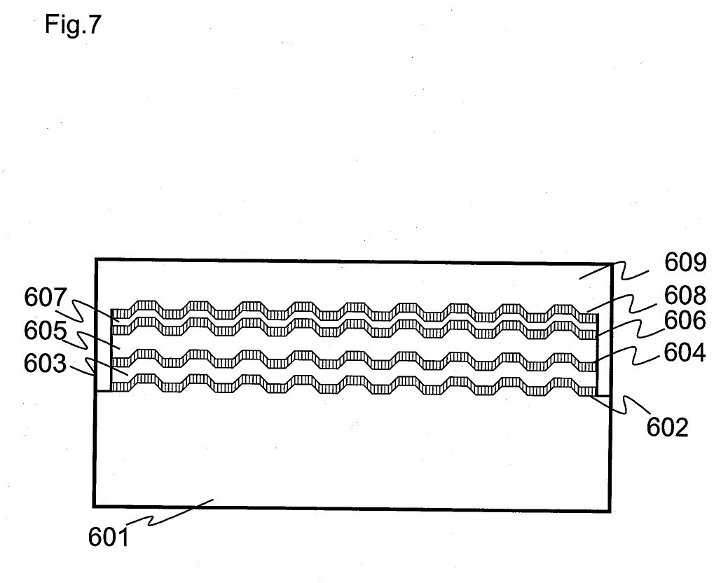

In Embodiment 3, description is to be made to a method of manufacturing a 4-layered information recording medium having four information layers as shown in FIG. 7.

The 4-layered information recording medium is constituted by stacking four information layers above a molded resin substrate 601 to which an information surface of guide grooves comprising a concave/convex shape is transferred and formed on one side.

In the 4-layered information recording medium, as shown in FIG. 7, there are disposed a first information layer 602 disposed so as to be in contact with a first information surface formed to the molded resin substrate 601 and a first resin intermediate layer 603 stacked so as to be in contact with the first information layer 602 and having a second information surface comprising a concave/convex shape on one side.

Further, in the 4-layered information recording medium, there are arranged a second information layer 604 disposed so as to be in contact with the second information surface and a second resin intermediate layer 605 stacked so as to be in contact with the second information layer and having a third information surface comprising a concave/convex shape on one side.

Further, in the 4-layered information recording medium, there are arranged a third information layer 606 disposed so as to be in contact with the third information surface and a third resin intermediate layer 607 stacked so as to be in contact with the third information layer and having a fourth information surface comprising a concave/convex shape on one side.

Further, in the 4-layered information recording medium, there are arranged a fourth information 608 disposed so as to be in contact with the fourth information surface and a protection layer 609 disposed so as to be in contact with the fourth information layer 608.

The molded resin substrate 601 is formed of a disk plate comprising a polycarbonate or acrylic resin having approximately an outer diameter of φ 120 mm, a center bore diameter of φ 15 mm and a thickness of 1.0 to 1.1 mm so as to have a configurational compatibility with CD or DVD, or an optical disk such as a Blu-ray disk. An information surface such as guide grooves formed with concavity and convexity is formed on one side of the molded resin substrate 601 by resin molding such as an injection molding method using the metal stamper 309 shown in FIG. 9(f). The molded resin substrate 601 was prepared by using a polycarbonate in the Embodiment 3.

In a case where the information recording medium is a read only medium, it may suffice that the first information layer 602 at least has characteristics of reflecting a reproduction light and it is formed, for example, from a reflection material including Al, Ag, Au, Si, SiO₂, TiO₂, etc. by using a method such as sputtering or vapor deposition.

Further, in a case where the information recording medium is a medium capable of recording, since it is necessary to write information by irradiation of a recording light, it contains at least a layer comprising, for example, phase change material such as GeSbTe or a recording material, for example, an organic dye such as phthalocyanine and may optionally contain a layer such as a reflection layer or a boundary layer for improving the recording/reproduction characteristics.

Also the second information layer 604, the third information layer 606, and the fourth information layer 608 can be formed in the same manner. However, since recording or reproduction is conducted by entering a recording or reproduction light from the side of the protection layer 609 to respective information layers, it is necessary to constitute such that the transmittance to the wavelength of the recording or reproduction light is increased successively from the first information layer to the fourth information layer.

In the Embodiment 3, description is to be made by using the result of investigation in a rewritable 4-layered information recording medium having an information layer comprising a rewritable phase change material.

The rewritable phase change material is a material capable of taking two or more states of different optical characteristics due to the heat by the irradiation of recording or reproduction light and it is preferably a material that the reaction can be changed irreversibly.

For example, materials containing O and M (in which M is one or plurality of elements selected from Te, Al, Si, Ti, V, Cr, Mn, Fe, Co, Ni, Cu, Zn, Ga, Ge, Zr, Nb, Mo, Ru, Rh, Pd, Ag, In, Sn, Sb, Hf, Ta, W, Re, Os, Ir, Pt, Au, and Bi) are preferred.

Further, also a structure in which not only the material described above but also a dielectric material is laminated is preferred. However, materials contained in the information layer are not restricted only to such materials.

Further, the effect of the present invention does not change also in the case of using a metal reflection film such as of Ag or Al alloy used for a read only medium not being restricted only to the rewritable phase change material.

Further, the effect of the present invention does not change also in a case of using a phase change material capable of conducting recording repetitively.

Further, while description is made herein to the optical information recording medium of the 4-layered structure, the number of the information layers is not restricted to 4.

Further, the first resin intermediate layer 603 is substantially transparent to the recording or reproduction light and can use, for example, a UV-ray stiffening resin mainly comprising an acrylic component or a radiation-stiffening resin such as an epoxy type UV-ray stiffening resin.

The substantially transparent referred to herein means to have a transmittance of 90% or higher to the wavelength of the recording or reproduction light and a material having a transmittance of 95% or higher is more preferred.

The method of preparing the first resin intermediate layer 603 includes a step of coating a liquid radiation-stiffening resin on the first information layer 602 by using an ink jet coating method to be described later and a step of transferring the information surface to the radiation-stiffening resin by utilizing the transfer stamper having an information surface such as pits or guide grooves.

The method of manufacturing the 4-layered information recording medium is identical with that explained for the Embodiment 1 or the Embodiment 2 and conducts the step of forming the resin intermediate layer and a transfer step for the information surface repetitively.

Further, the thickness of the protection layer 609 is preferably set to about 40 μm or more for mitigating the effect given to the recording/reproduction characteristics of each of information layers due to dusts deposited to the surface of the protection layer or injuries.

The thicknesses for the first resin intermediate layer 603, the second resin intermediate layer 605, and the third resin intermediate layer 607 are different respectively for decreasing the effect of cross talk or interference from other layers and they were designed to the thickness of about 15 μm, about 20 μm, and about 10 μm. Further, the thickness of the protection layer was set to about 55 μm. However, the designed value for the thickness of the resin intermediate layer is an example and the effect of the present invention does not change also in other designed value for the thickness.

While the outline of the constitution and the manufacturing method of the multi-layered information recording medium in the Embodiment 3 of the present invention has been described simply, the method of manufacturing the multi-layered information recording medium of the present invention has a feature in the method of forming the resin intermediate layer or the protection layer and, accordingly, other step may be any step.

Table 5 shows the conditions when the resin intermediate layer was prepared.

TABLE 5

| | | | | | | | | | Variation | |
|---|---|---|---|---|---|---|---|---|---|---|
| | | | Viscosity (mPa · s) | | | Heater | | Coating | of | |
| | Coating | | at | at | upon | heating | Resolution | thickness | thickness | Protruded |
| Resin layer | order | Resin | 20° C. | 50° C. | discharge | (50° C.) | (dpi) | (μm) | (μm) | resin |
| Second resin | 1 | R1 | 180 | 20 | 20 | yes | 360 | 20.8 | ±1.4 ◯ | ◯ |
| intermediate layer | 2 | R1 | 180 | 20 | 20 | yes | 360 | | | |
| | 3 | R3 | 10 | — | 10 | none | 180 | | | |
| First resin | 1 | R1 | 180 | 20 | 20 | yes | 360 | 14.6 | ±1.3 ◯ | ◯ |
| intermediate layer | 2 | R3 | 10 | — | 10 | none | 180 | | | |
| Third resin | 1 | R6 | 150 | 16 | 16 | yes | 360 | 10.9 | ±1.1 ◯ | ◯ |
| intermediate layer | 2 | R4 | 5 | — | 5 | none | 180 | | | |
| Protection layer | 1 | R1 | 180 | 20 | 20 | yes | 540 | 55.9 | ±1.9 Δ | ◯ |
| | 2 | R1 | 180 | 20 | 20 | yes | 540 | | | |
| | 3 | R1 | 180 | 20 | 20 | yes | 540 | | | |
| | 4 | R3 | 10 | — | 10 | none | 180 | | | |

As shown in Table 5, as a result of stack-coating plurality of resins of different viscosities, thickness about within ±1 μm relative to the aimed thickness was attained. Further, also the variation in the thickness showed a good result as within ±1.5 μm for the resin intermediate layer and a good result as within ±2 μm was obtained also for the protection layer attained by stack-coating for 4 times.

In Table 5, resins of an identical viscosity were coated successively but this is not restrictive and, for example, a resin of high viscosity and a resin of low viscosity may be coated alternately.

Then, the manufactured 4-layered information recording media were evaluated for electric characteristics by using a disk evaluation machine DDU-1000 manufactured by Pulstec Industrial Co. Ltd. The disk evaluation machine is an evaluation machine having a semiconductor laser at wavelength of 405 nm as a light source and an optical pick-up having an objective lens with NA of 0.85, and capable of evaluating electric characteristics of Blu-ray disks.

Evaluation for focus residue and the evaluation for limit equalized jitter were conducted while setting the disk rotational linear velocity during reproduction to 4.9 m/s. The jitter value is an index of representing fluctuation of reproduction signals with time and the reproduction signal quality is higher as the value is smaller. In this case, as the jitter index, 8.5% or less was defined as an aimed value for each of the information layers.

Further, the aimed value of the focus residue was ±45 nm or less in a frequency band of 1.8 kHz to 10 kHz and 32 nm or less in a frequency band of 10 kHz or more. The result is shown in Table 6.

TABLE 6

| | Focus residue (nm) | | Jitter |
|---|---|---|---|
| Information layer | 1.8 kHz-10 kHz | 10 kHz - | (%) |
| First information | ±22 ◯ | 11 ◯ | 6.4 ◯ |
| layer | | | |
| Second information | ±31 ◯ | 20 ◯ | 7.9 ◯ |
| layer | | | |
| Third information | ±27 ◯ | 18 ◯ | 7.2 ◯ |
| layer | | | |
| Fourth information | ±25 ◯ | 17 ◯ | 7.3 ◯ |
| layer | | | |

As shown in Table 6, favorable focus residues and jitter values were confirmed in each of the information layers.

While description has been made to the information recording medium of the 4-layered structure having four information layers, the effect of the present invention does not change when the number of information layers is different.

Then, coating was conducted by using same resin materials from the resin of low viscosity different from Table 6 to manufacture a 4-layered information recording medium. Table 7 shows the conditions when the resin intermediate layers were prepared.

TABLE 7

| | | | | | | | | | Variation | |
|---|---|---|---|---|---|---|---|---|---|---|
| | | | Viscosity (mPa · s) | | | Heater | | Coating | of | |
| | Coating | | at | at | upon | heating | Resolution | thickness | thickness | Protruded |
| Resin layer | order | Resin | 20° C. | 50° C. | discharge | (50° C.) | (dpi) | (μm) | (μm) | resin |
| Second resin | 1 | R3 | 10 | — | 10 | none | 180 | 21 | ±1.7 Δ | ◯ |
| intermediate layer | 2 | R1 | 180 | 20 | 20 | yes | 360 | | | |
| | 3 | R1 | 180 | 20 | 20 | yes | 360 | | | |
| First resin | 1 | R3 | 10 | — | 10 | none | 180 | 15.2 | ±1.6 Δ | ◯ |
| intermediate layer | 2 | R1 | 180 | 20 | 20 | yes | 360 | | | |
| Third resin | 1 | R4 | 5 | — | 5 | none | 180 | 10.8 | ±1.5 ◯ | ◯ |
| intermediate layer | 2 | R1 | 150 | 16 | 16 | yes | 360 | | | |
| Protection | 1 | R3 | 10 | — | 10 | none | 180 | 55.8 | ±2.0 Δ | ◯ |
| layer | 2 | R1 | 180 | 20 | 20 | yes | 540 | | | |
| | 3 | R1 | 180 | 20 | 20 | yes | 540 | | | |
| | 4 | R1 | 180 | 20 | 20 | yes | 540 | | | |

As shown in Table 7, as a result of stack-coating a plurality of resins of different viscosities, thickness substantially within ±1 μm relative to the aimed thickness was attained. Also for variation in the thickness, a good result as within ±2.0 μm was shown for the resin intermediate layer, and a good result as within ±2 μm was obtained also for the protection layers attained by stack-coating for four times.

Then, electric characteristics were evaluated for the manufactured 4-layered information recording medium by using a disk evaluation machine DDU-1000 manufactured by Pulstec Industrial Co. Ltd. The evaluation conditions and the evaluation index are identical with those explained previously. Table 8 shows the result of the evaluation.

TABLE 8

| | Focus residue (nm) | | Jitter |
|---|---|---|---|
| Information layer | 1.8 kHz-10 kHz | 10 kHz - | (%) |
| First information | ±25 ◯ | 17 ◯ | 6.5 ◯ |
| layer | | | |
| Second information | ±34 ◯ | 26 ◯ | 8.0 ◯ |
| layer | | | |
| Third information | ±32 ◯ | 22 ◯ | 7.5 ◯ |
| layer | | | |
| Fourth information | ±31 ◯ | 23 ◯ | 7.5 ◯ |
| layer | | | |

As shown in Table 8, favorable focus residues and jitters values were confirmed for each of the information layers.

While description has been made to the information recording medium of the 4-layered structure having four information layers, the effect of the present invention does not change when the number of information layers is different.

Further, while description has been made to a case of using a radiation-stiffening resin as the stiffening resin in the embodiments described above. This is not restrictive and any resin, for example, a thermosetting resin may be used so long as it can be coated by an ink jet head.

According to the method of manufacturing the multi-layered information recording medium and the apparatus for manufacturing the multi-layered information recording medium described above, they are useful as a construction method for forming the resin layer such as the resin intermediate layer or the protection layer in the multi-layered information recording medium and can be utilized, particularly, in the resin layer stacking process, for example, for Blu-ray disks, etc.

### INDUSTRIAL APPLICABILITY

The method of manufacturing the multi-layered information recording medium, the apparatus for manufacturing the multi-layered information recording media, and the multi-layered information recording medium of the present invention have advantages of preparing a resin intermediate layer of a desired uniform thickness, attaining a good surface smoothness and having good signal characteristics even for a resin layer, for example, of more than 10 μm and they are useful as the multi-layered information recording medium having two or more information layers, as well as the manufacturing method thereof and the manufacturing apparatus therefor.

1. A method of manufacturing a multi-layered information recording medium at least having a substrate, a plurality of information layers disposed above the substrate, a resin intermediate layer disposed between each of the information layers, and a protection layer disposed above the information layers, in which
formation of the resin intermediate layer includes an ink jet coating step of stack-coating at least two kinds of stiffening resins of different viscosities above the substrate while relatively moving at least one of the substrate and the ink jet head, and,
a step of transferring and forming an information surface to the stiffening resin.

2. A method of manufacturing a multi-layered information recording medium according to claim 1, wherein a discharge width of the stiffening resin in the ink jet head is equal to or greater than a width of the substrate in a relation perpendicular to a running direction of the ink jet head.

3. A method of manufacturing a multi-layered information recording medium according to claim 1, wherein the stiffening resin is stiffened on every coating to the substrate and a next stiffening resin is coated after stiffening.

4. A method of manufacturing a multi-layered information recording medium according to claim 1, wherein the stiffening resins are coated in order of higher viscosity.

5. A method of manufacturing a multi-layered information recording medium according to claim 1, wherein the stiffening resins are coated in order of lower viscosity.

6. A method of manufacturing a multi-layered information recording medium according to claim 1, wherein a resin having a viscosity upon discharge at the ink jet head within a range from 5 mPa·s to 20 mPa·s is used as the stiffening resin.

7. A method of manufacturing a multi-layered information recording medium according to claim 1, wherein a (n+1)ₜₕ coating region of the stiffening resin stack-coated above the substrate is within an nth coating region, where n is a positive integer of 1 or greater.

8. A method of manufacturing a multi-layered information recording medium according to claim 1, wherein a number of drops per unit area of a droplet of the stiffening resin dropping to the substrate is increased as the viscosity of the stiffening resin is increased.

9. A method of manufacturing a multi-layered information recording medium according to claim 1, wherein a number of drops per unit area of the stiffening resin is set within a range from 180 dpi×180 dpi to 540 dpi×540 dpi.

10. A method of manufacturing a multi-layered information recording medium according to claim 1, wherein a number of drops per unit area of the stiffening resin is set within a range from 180 dpi×180 dpi to 720 dpi×720 dpi.

11. A method of manufacturing a multi-layered information recording medium according to claim 1, wherein coating is conducted in the ink jet coating step by a plurality of the ink jet heads each having an identical structure.

12. A method of manufacturing a multi-layered information recording medium according to claim 1, wherein the stiffening resin is a radiation-stiffening resin.

13. An apparatus for manufacturing a multi-layered information recording medium for discharging a stiffening resin onto a substrate while relatively moving at least one of the substrate and an ink jet head, comprising:
a plurality of the ink jet heads provided for every different kind of the discharged stiffening resin,
wherein the stiffening resin is stack-coated to the substrate.

14. An apparatus for manufacturing a multi-layered information recording medium according to claim 13, wherein a discharge width of the stiffening resin in the ink jet head is equal to or greater than a width of the substrate in a relation perpendicular to a running direction of the ink jet head.

15. An apparatus for manufacturing a multi-layered information recording medium according to claim 13, wherein a nozzle resolution of the ink jet head is within a range from 180 npi to 540 npi.

16. An apparatus for manufacturing a multi-layered information recording medium according to claim 13, wherein a nozzle resolution of the ink jet head is within a range from 180 npi to 720 npi.

17. An apparatus for manufacturing a multi-layered information recording medium according to claim 13, wherein a plurality of the ink jet heads have each an identical structure.

18. An apparatus for manufacturing a multi-layered information recording medium according to claim 13, wherein a (n+1)ₜₕ coating region of the stiffening resin stack-coated above the substrate is set within an nth coating region.

19. An apparatus for manufacturing a multi-layered information recording medium according to claim 13, wherein the stiffening resin is a radiation-stiffening resin.

20. A multi-layered information recording medium manufactured by using the method of manufacturing a multi-layered information recording medium according to claim 1.
